(19) United States
(12) Patent Application Publication
(10) Pub. No.: US 2026/0105635 A1
(43) Pub. Date: Apr. 16, 2026

(54) IMAGING CALIBRATION TARGETS

(71) Applicant: Hewlett-Packard Development Company, L.P., Spring, TX (US)

(72) Inventors: Fred Charles Thomas, III, Fort Collins, CO (US); Santiago Garcia-Reyero Vinas, San Diego, CA (US); Miles Maxwell Claver, Fort Collins, CO (US); Joshua Alan St. John, San Diego, CA (US)

(73) Assignee: Hewlett-Packard Development Company, L.P., Spring, TX (US)

(21) Appl. No.: 18/913,553

(22) Filed: Oct. 11, 2024

(51) Int. Cl. G06T 7/80; H04N 23/56

(52) U.S. Cl. CPC G06T 7/80; H04N 23/56; G06T 2207/10152

(57) ABSTRACT

In some examples, the imaging system can include a first calibration object having a first surface configuration to visually indicate a polarization orientation of light emitted thereto. The imaging system may include a light source to emit light in accordance with a plurality of light settings, each of the light settings defining a different relative position of the light source with respect to the first calibration object. The imaging system can include an imaging device. The imaging system can include a processor to instruct the imaging device to capture a plurality of images of the first calibration object illuminated with the light source with different light settings of the plurality of light settings and to calibrate image data corresponding to a sample under the same different light settings based on the plurality of images captured by the imaging device.

### BACKGROUND

Photometric imaging devices facilitate the acquisition of information, which can be used in subsequent processes (e.g., rendering processes). Photometric techniques can include photometric stereo, in which the information acquired pertains to the surface of a material (e.g., sample) as the surface is under different lighting conditions (e.g., from different relative positions).

### SUMMARY

The systems, methods, and devices of this disclosure each have several innovative aspects, no single one of which is solely responsible for all of the desirable attributes disclosed herein. Details of implementations of the subject matter described in this specification are set forth in the accompanying drawings and the description below.

In some aspects, the techniques described herein relate to an imaging system including: a first calibration plate including a first calibration object, the first calibration object including a first surface configuration to visually indicate a polarization orientation of light emitted thereto; a light source to emit light in accordance with a plurality of light settings, each of the light settings defining a different relative position of the light source with respect to the first calibration object; an imaging device; and a processor to instruct the imaging device to capture a plurality of images of the first calibration object illuminated with the light source with different light settings of the plurality of light settings and to calibrate image data corresponding to a sample under the same different light settings based on the plurality of images captured by the imaging device.

In some aspects, the techniques described herein relate to an imaging system including: a plurality of lamps arranged to emit light from different positions within the imaging system; a first calibration object including a first surface configuration to reflect light from the plurality of lamps; an imaging device having a field of view including the first calibration object; and a processor to control the plurality of lamps to subsequently emit light from the different positions, the imaging device to obtain image data corresponding to the first calibration object while the first calibration object reflects the light emitted by the plurality of lamps, and the processor to obtain calibration data to be used in an image capturing operation based on the image data.

In some aspects, the techniques described herein relate to a calibration method including: illuminating a first calibration object with light from different relative positions using a light source, the first calibration object having a first surface configuration to visually indicate a polarization direction of light emitted by the light source; obtaining image data corresponding to the first calibration object illuminated with the light source from the different relative positions; and obtaining calibration data based on the first plurality of images corresponding to the first calibration object, wherein the calibration data is indicative of polarization deviations of the light emitted from the light source from the different relative positions.

### BRIEF DESCRIPTION OF THE DRAWINGS

Throughout the drawings, reference numbers are re-used to indicate correspondence between referenced elements. The drawings are provided to illustrate examples of the subject matter described herein and not to limit the scope thereof.

FIG. 1A illustrates a schematic cross-sectional perspective view of an imaging system including a light source and a calibration object in accordance with some examples of the present disclosure.

FIG. 1B illustrates a schematic cross-sectional side view of a calibration object in accordance with some examples of the present disclosure.

FIG. 1C illustrates a schematic cross-sectional perspective view of an imaging system including a light source and multiple calibration objects in accordance with some examples of the present disclosure.

FIG. 2A illustrates a schematic cross-sectional perspective view of an imaging system including a light source in the form of a plurality of lamps and a calibration object in accordance with some examples of the present disclosure.

FIG. 2B illustrates a schematic cross-sectional perspective view of an imaging system including light source in the form of a plurality of lamps and a calibration plate having a calibration object in accordance with some examples of the present disclosure.

FIG. 3 illustrates a schematic top view of a calibration plate including a calibration object and multiple calibration patterns in accordance with some examples of the present disclosure.

FIGS. 4A-4B illustrate a schematic perspective view of a housing for an imaging system in accordance with some examples of the present disclosure.

FIG. 5 illustrates a block diagram of at least some of the components of the photometric imaging system in accordance with some examples of the present disclosure.

FIG. 6 illustrates a photometric imaging calibration process in accordance with some examples of the present disclosure.

FIG. 7 illustrates a photometric imaging process including a photometric imaging calibration process in accordance with some examples of the present disclosure.

### DETAILED DESCRIPTION

A photometric imaging device, such as a photometric stereo imaging device, may include a target area to receive a sample, a light source (e.g., a lamp) for illuminating the sample, an imaging device (e.g., a camera) to acquire or capture images of the illuminated sample under different lighting conditions (e.g., relative locations with respect to the sample, brightness levels, and polarization, including linear polarized light), and a processor. In an imaging operation of the photometric imaging device, the light source emits light to illuminate the sample from different relative positions and the imaging device captures images of the illuminated sample. The processor can facilitate the imaging operation through at least instructing the imaging device to acquire the images under the different lighting conditions. These images can be used in a subsequent image rendering process.

Photometric imaging systems, particularly photometric stereo, may have a limited accuracy when capturing the true colors of a sample, in addition to the direction and/or polarization state of the light (e.g., the phase or elliptical orientation of the light) to be reflected from the sample. The limited accuracy can impact subsequent image analysis, resulting in poor color reconstruction and poor physically based renderings generally, owing in part to the possibly inaccurate light polarization information. In some examples, calibration objects (e.g., polarization calibration objects) and patterns may be used to obtain image data that can facilitate calibrating a photometric imaging operation.

### Example Photometric Imaging System With Calibration Object

Various examples disclosed herein relate to an imaging system (e.g., a photometric imaging system or a near-light photometric imaging system) that can be implemented with calibration targets, which may include polarization calibration objects and/or a plurality of calibration patterns to calibrate image data for light direction, light polarization state, color, etc. As described herein, the calibration targets can be implemented directly within an imaging system. For example, the calibration targets may be printed or etched onto a surface of an imaging system within the field of view of an imaging device, such as a camera. In some examples, the calibration targets may be included on a calibration plate. The calibration plate may be a planar element/substrate upon which the calibration targets may be incorporated and/or printed or etched onto. For example, polarization calibration objects may be fabricated separately from the calibration plate and adhered to or inserted into the plate. In another example, various calibration patterns, such as slanted L patterns may be directly printed onto a surface of the calibration plate with a high-resolution printer (e.g., 2400 dpi or at least at a dpi equivalent to 2 dots per camera pixel at capture plane resolution—Nyquist criteria) such that the slanted L patterns are coplanar with the polarization calibration objects. The calibration plate, as described herein, can include a plurality of different types of calibration targets for calibrating different features of the imaging system. In some cases, the number and the type of calibration targets used in a calibration plate may be selected to meet some user-related requirements. In some cases, multiple calibration patterns may be implemented in addition to the calibration object, and collectively, these calibration patterns and calibration object(s) can help to calibrate the image data of the light reflected from the calibration patterns and the calibration object(s), as this image data can include information pertaining to the light polarization state, light direction, color, etc.

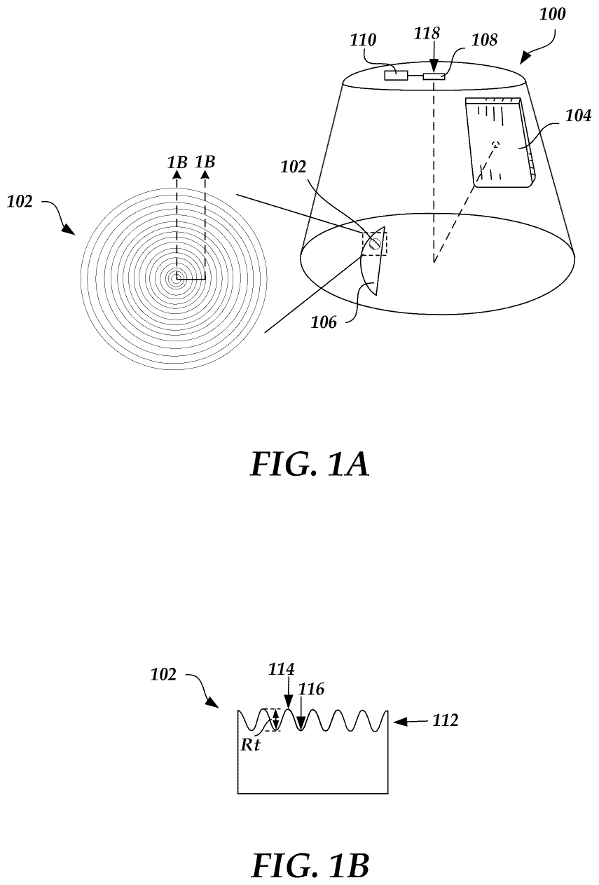

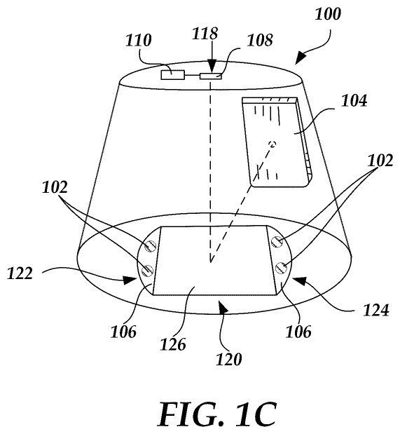

FIG. 1A illustrates a perspective view of an imaging system 100 in which a polarization calibration object 102 is implemented. The imaging device comprises a light source having optoelectronic emitters. In some cases, the light source may have properties to help facilitate near-light illumination, as described herein. Examples of the optoelectronic emitters in the light source can include light emitting diodes (LEDs), halogen lamps, tungsten filament lamps, fluorescent lamps, plasma lighting, and high-quality red, green, and blue (RGB) LED systems. The light source can be defined to include one or more lamps (e.g., lamp 104). The imaging system 100 further comprises a calibration plate 106 including the polarization calibration object 102, an imaging device 108, and a processor 110.

The light source or lamp 104 may emit light in accordance with light settings. As described herein, light setting refers to a set of configurations associated with the light emitted by the source, such as the orientation of the light to be emitted towards the sample (e.g., a relative location of the light relative to the sample) during an imaging operation, the brightness level of the light to be emitted towards the sample, color temperature of the light to be emitted towards the sample, or color/wavelength of the light to be emitted towards the sample, among others.

In some examples, a light source in the form of a single lamp can emit light in accordance with different light settings. The single lamp can be rotated or otherwise moved to other positions within the imaging system 100 to illuminate the polarization calibration object 102 from different locations. For example, the light source can be moved relative to the polarization calibration object 102. In some cases, the polarization calibration object 102 can be moved with respect to the light source. In some cases, the imaging system 100 may simultaneously illuminate the polarization calibration object 102 and a sample within a field of view of an imaging device 108.

In other examples, the light source may be in the form of a plurality of lamps, each corresponding to a different set of light settings (i.e., each of the lamps to emit light from a different relative location of the light relative to polarization calibration object 102 and the sample, if any). In some cases, where the imaging system 100 includes a target area to receive a sample, the light settings are defined to be a relative position of the light source with respect to the polarization calibration object 102 and the target area. These light settings may further comprise, but are not limited to, color temperature, color/wavelength, and brightness level.

In some examples, the lamp 104 (or lamps when having a light source in the form of a plurality of lamps) may have certain properties relevant to enabling near-light illumination. As used herein, near-light illumination refers to a light source capable of emitting light with a uniform distribution over an area to be imaged (e.g., a target area), has an approximately constant color temperature and brightness, and has a relatively high color rendering index (CRI) value. For example, the lamp 104 may emit light in accordance with a light setting such that the emitted light has a uniform light distribution and the lamp 104 may include optoelectronic emitters that may be selected for their ability to provide a relatively constant color temperature across a wide range of brightnesses. Having a relatively constant color temperature at different brightness levels can help improve the quality of imaging data. For example, the color interpretation may be more consistent and accurate, thereby reducing variability in imaging results and enhancing the imaging process. These optoelectronic emitters may include LEDs; halogen lamps; tungsten filament lamps; fluorescent lamps; plasma lighting; and high-quality red, green, and blue (RGB) LED systems. In other cases, optoelectronic emitters may be selected for their ability to provide a constant color temperature and for having a color rendering index (CRI) value greater than 90%. These optoelectronic emitters may include high-quality LEDs; halogen lamps; tungsten filament lamps; high-quality fluorescent lamps; and high-quality RGB LED systems. The light emitted from the lamp 104 can be selected to have a color temperature of approximately 6,500 K. In other examples, the light can have a color temperature in a range of approximately 4,500 K to 10,000 K, in a range of approximately 4,500 K and 7,000 K, or in a range of 6,000 K and 7,000 K. In some cases, a brightness of the lamp 104 can be adjusted by adjust an amount of current (e.g., drive current) provided to it. As the current being delivered is adjusted, the lamp 104 may maintain an approximately constant color temperature (e.g., the color temperature may fluctuate +/−100 K and still be considered a constant color temperature.

The calibration plate 106 can include a plurality of calibration targets. These calibration targets can include various types of tags, markers, or objects that can be used to calibrate different features of an imaging system (e.g., settings of a camera) and/or image data acquired through the imaging system. One such object, is the polarization calibration object 102 for polarization state calibrations. In some other examples, the calibration plate 106 may include a different number of polarization calibration objects.

The polarization calibration object 102 may be a reflective tag that can be implemented in the imaging system 100 to extract the image location dependent polarization state properties of light emitted by the lamp 104 and reflected from the surface of the reflective tag. The polarization calibration object 102 can be formed from an optically reflective material that can have a plurality of areas over ranges of reflective orientations that are greater in size than the wavelength of light being reflected (e.g., 0.4 μm-0.7 μm) that do not alter the polarization state of the light and reflect light back to the sensor. In some cases, the optically reflective material does not alter the incident light polarization state (e.g., ellipticity) by more than 5%. In some cases, the optically reflective material may have an albedo (e.g., a specular reflectance) in a range between approximately 0.5 and 1.0. As shown in FIGS. 1A and 1B, the polarization calibration object 102 can have a surface configuration 112 (e.g., a fabricated surface) to visually indicate a polarization orientation of light emitted by the lamp 104 thereto. In some examples, the polarization calibration object 102 can be formed from materials that reflect linearly polarized light without altering its polarization or color state. These materials may be non-birefringent, non-dichroic, and have multiple areas with dimensions larger than the wavelength of light to be reflected from the material or have a continuously uniform reflective surface. These materials can include materials having metallic surfaces (e.g., aluminum, silver, gold), dielectric mirrors (e.g., multilayer coatings where alternating layers have different refractive indices), and polished metal oxides (e.g., titanium dioxide, zinc oxide).

Returning to FIG. 1A, the polarization calibration object 102 in the dashed box in FIG. 1A is magnified to illustrate one example of a continuous wave patterned surface including a cyclically modulated and circularly patterned surface. The surface configuration 112 of the polarization calibration object 102 can be fabricated through a machining process or an abrasive process (e.g., steel brush or abrasive film) or a photolithographic mastering process or through a chemical mechanical polishing (CMP) process. In some examples, the surface configuration 112 can be obtained through an etching process (e.g., wet etch). In some cases, the polarization calibration object 102 is a monolithic substrate with a fabricated surface. In some cases, rather than being monolithic in nature, the polarization calibration object 102 can be made from sub-objects. The use of monolithic polarization calibration objects allows for reducing the chances of misalignment of the sub-objects forming the polarization calibration object.

As illustrated, the polarization calibration object 102 can be circular in shape and include a plurality of concentric marks (e.g., circular concentric marks). For example, the polarization calibration object 102 can include a diameter in a range of approximately 35 mm and 40 mm and can include between approximately 10 and 4000 concentric rulings within the polarization calibration object 102. The circular shape and plurality of circular concentric marks can allow the polarization calibration object 102 to have an omnidirectional capability, as the polarization calibration object 102 having these features can reflect light emitted from light sources placed at different positions relative to the polarization calibration object 102. Although the polarization calibration object 102 is shown to have circular concentric markings, the polarization calibration object 102 can include different arrangements of marks distributed across the surface of the polarization calibration object 102. Additionally, although the polarization calibration object 102 is shown to be circular in shape, the polarization calibration object 102 can take on other shapes. For example, the polarization calibration object 102 can be octagonal, rectangular, or triangular, among other shapes. The shape of the polarization calibration object 102 and/or the shape of the markings may be dependent on the number and positioning of the lamps 104 relative to the polarization calibration object 102 in the imaging system 100. For example, as described herein, a circular polarization calibration object 102 having a plurality of circular concentric marks can facilitate the acquisition of omnidirectional data. In another example, if four lamps were to be implemented and to be placed in a rectangular arrangement with respect to the polarization calibration object 102, the polarization calibration object 102 could include a rectangular shape having circular concentric marks; a rectangular shape having rectangular concentric marks; an elliptical shape having elliptical concentric marks; or a circular shape having circular concentric marks. The shape and markings of the polarization calibration object 102 (e.g., a fabricated surface comprising a plurality of markings) should be able to reflect light that is incident on it from any light source positioned within the imaging system back to the imaging device 108 (e.g., camera). Such a polarization calibration object 102 can help render visible the light sources' polarized reflected light with unaltered polarization state to the imaging device 108. In the example where the polarization calibration object 102 includes circular concentric markings, the lighting sources' polarized reflected light with unaltered polarization state can be visible to the imaging device 108 for approximately all positional placements of the polarization calibration object 102 within the field of view of the imaging device 108.

FIG. 1B shows a side view of the polarization calibration object 102 and illustrates that the surface can be fabricated to have a sinusoidal waveform. The surface configuration 112 can include a plurality of peaks 114 and a plurality of grooves 116. The plurality of peaks 114 and plurality of grooves 116 can comprise an approximately sinusoidal pattern. In some cases, the plurality of peaks 114 and plurality of grooves 116 may not form a sinusoidal pattern. In some examples, the pitch of the grooves (or the pitch of the peaks) may be less than 5 mm. In some examples, the pitch of the grooves may be in a range between approximately 0.9 μm and 20 μm, or 0.98 μm and 18.2 μm, or 100 μm and 400 μm. In some cases, the pitch does not need to be of a consistent or fixed value. The distance between the top peak and the lowest groove over the entire polarization calibration object 102 (e.g., Rt value) can be in a range between approximately 3 μm and 13 μm, or 3.9 μm and 12 μm, or 50 μm and 400 μm. For a given light illumination placement and orientation, the depth of the groove does not occlude the lamp's Snell's Law governed specular reflective path off of the wave pattern back to the camera. For example, as the incident angle of the light becomes shallower or closer to planar with the surface of the polarization calibration object 102, the pitch should be increased relative to the peak to valley of the wave form dimension.

The imaging device 108 (e.g., FIG. 1A) can capture an image of a field of view that includes the calibration plate 106. In some examples, the imaging device 108 can be a camera. For example, the camera can be a color complementary metal-oxide semiconductor (CMOS) imager. In some examples, the camera can include approximately between 10 MP and 200 MP. In some examples, the camera includes 108 MP. In some examples, the imaging device 108 can include additional features. For example, the imaging device 108 can include a 7-lens element for high fidelity images over a target area, an optical image stabilizer (e.g., x and y nano stage that incrementally move the lens relative to the imager), and/or focusing capabilities that can include autofocusing capabilities or manual focusing capabilities. In some examples, the imaging device 108 can be a mobile phone camera module. In some cases, the imaging system 100 can include more than one imaging device 108. For example, the imaging system 100 can include two imaging devices 108 (e.g., two cameras) to allow for dual photometric stereo sampling and adding the capability of 3D stereo vision true depth measurement to the system. In some cases, the imaging device 108 may be removable. For example, the imaging system 100 can include an element (e.g., a mount, imaging device holder, etc.) or a receptacle to receive the imaging device 108, which can facilitate placement of the imaging device 108 along an imaging axis 118.

The polarization calibration object 102 can be located within a field-of-view (FOV) of the imaging device 108. In some examples, and as shown in FIG. 1A, the polarization calibration object 102 can be located within a calibration plate 106, and the entire calibration plate 106 can be located within the FOV of the imaging device 108. Disposing the polarization calibration object 102 within the FOV of the imaging device 108 can allow for simultaneous imaging of the polarization calibration object 102 and a sample (not shown), which allows a user the option to carry out a calibration before imaging a sample, during imaging of a sample, and/or post-imaging of a sample. The simultaneous imaging of the polarization calibration object 102 and the sample allows for reducing the overall time for the imaging capturing operation. In some cases, the imaging device 108 may have an aspect ratio FOV that is 4:3. In some cases, the aspect ratio may be 16:9 or 3:2. Having a rectangular shape, the FOV of the imaging device 108 can be divided into several regions, which can facilitate simultaneous imaging of calibration targets and a sample. For example, as shown in FIG. 1C, the FOV can include a first region 120, a second region 122, and a third region 124. The first region 120 may correspond to a target area 126 to receive a sample to be imaged. In some cases, the target area 126 may have a shape that is rectangular, square, or circular, among other shapes. In some examples, the target area 126 may be centrally located with respect to the imaging axis 118. In some cases, the first region 120 may be 30 cm×30 cm in size. In some cases, the first region 120 may be 20 cm×20 cm, 100 cm×100 cm in size, or any other smaller or larger size for the first region within the FOV.

A calibration plate 106 can be included in the outer edge or the wing areas of the FOV, such that a calibration plate 106 (e.g., a first calibration plate) can be located within the second region 122 and a calibration plate 106 (e.g., a second calibration plate) can be located within the third region 124. In some cases, the calibration plates 106 are laterally spaced apart. In some cases, the calibration plates 106 can be symmetrically arranged with respect to the imaging axis 118. In some cases, the calibration plates 106 can be asymmetrically arranged with respect to the imaging axis 118. The symmetric configuration illustrated in FIG. 1C, allows for the inclusion of 2× image calibration areas in the FOV. A plurality of polarization calibration objects 102 can be included within each of the calibration plates 106. For example, the calibration plate 106 in the second region 122 can include two polarization calibration objects 102 and the calibration plate 106 in the third region 124 can include two polarization calibration objects 102. In some cases, greater or fewer polarization calibration objects 102 can be included within each of the calibration plates 106. In some cases, the calibration plate 106 can be fixed within the imaging system 100 or removable. Having a removable plate can allow a user to readily modify or customize the calibration targets to be implemented in the imaging system. In some cases, additional calibration plates 106 can be included. For example, four calibration plates can be included in the FOV. Additionally, although the calibration plate 106 is illustrated to have a shape similar to that of a semicircle, the calibration plate 106 can have other shapes (e.g., rectangular shape, etc.).

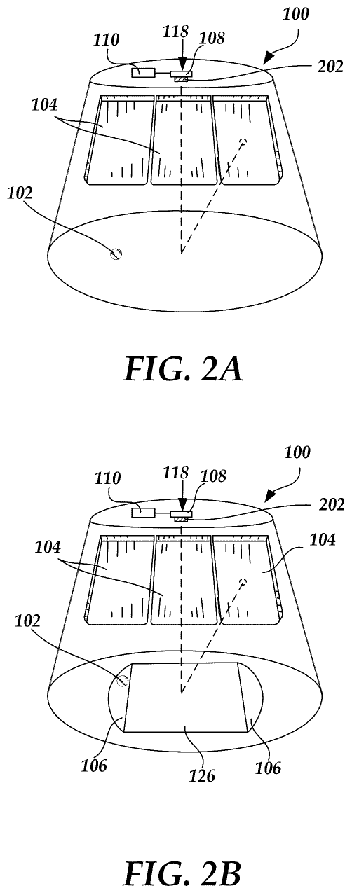

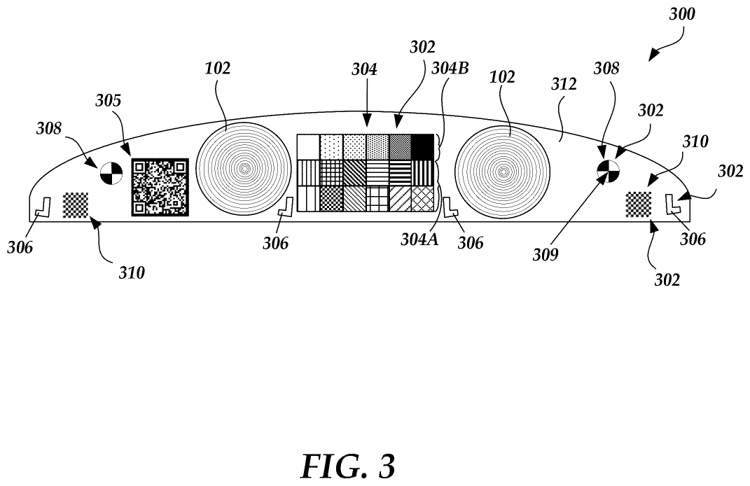

Alternative examples of imaging systems 100 are illustrated in FIGS. 2A and 2B. Unless otherwise noted, the components of FIGS. 2A and 2B are the same as or generally similar to the components of FIGS. 1A-1C, and alternatives noted above with respect to FIGS. 1A-1C are likewise applicable to the example imaging systems 100 of FIGS. 2A and 2B. Unlike FIGS. 1A-1C, in which a polarization calibration object 102 is implemented with a light source in the form of a single lamp 104 and imaging device 108, in the example imaging systems 100 of FIGS. 2A and 2B, the light source is in the form of multiple lamps located at different positions relative to the polarization calibration object 102 and the imaging device 108. In the cross-sectional views of FIGS. 2A and 2B, 3 lamps 104 are depicted. In some cases, the total number of lamps included can be 2 or more. For example, the imaging system 100 can include 8 lamps, where each of the 8 lamps is to emit light towards a sample and/or polarization calibration object 102, and where the lamps are positioned symmetrically about the imaging axis 118. In some cases, this emitted light will be linearly polarized. Further, as shown in FIG. 2A, the polarization calibration object 102 can be used within the imaging system 100 without a calibration plate 106. Although a single polarization calibration object 102 is depicted, more polarization calibration objects 102 can be included. For example, two, three, or four polarization calibration objects 102 may be included. Including more polarization calibration objects 102 may enable obtaining more image data pertaining to light direction and incident polarization phase measurements, which in turn can improve calibrations of the image data.

Where the polarization calibration object 102 can be used to measure the incident light polarization state phase orientation, a polarizer 202 can be included within the imaging system 100. As shown in FIGS. 2A and 2B, the polarizer 202 can be located along the imaging axis 118 between the imaging device 108 and the polarization calibration object 102. In some cases, the polarizer 202 may be a linear polarizer in which a polarization viewing state of the linear polarizer can be adjusted by physically rotating the linear polarizer. In some cases, the polarizer 202 may be an optical filter such as a liquid crystal tunable filter, where the polarization viewing state can be adjusted through varying a drive current provided to the liquid crystal tunable filter. In some cases, the polarizer 202 can be adjusted to modify a polarization viewing state while the polarization calibration object 102 is illuminated with light from a lamp 104. For example, a plurality of images captured may include the polarization calibration object 102 illuminated with light emitted from different positions relative to the polarization calibration object 102 for a given polarizer viewing state. The polarizer 202 can have its polarizer viewing state modified with respect to a first lamp (e.g., lamp 104) to capture a first image of the polarization calibration object 102 illuminated with the light. For example, the polarization direction of the polarizer 202 can be oriented at a polarization angle relative to the polarization direction of the light incident on the polarizer 202, where the angle can be in a range of approximately 0° (aligned)—90° (crossed). In some cases, the polarization angle can be modified to a plurality of angles to facilitate capturing images of the polarization calibration object 102 illuminated by the first lamp at different angles, which facilitates the measurement of the degree or nature of the specular/diffuse reflectance from the surface or albedo.

In some examples, the polarization calibration object 102 can be located within a calibration plate 106, and multiple calibration plates 106 can be used within the imaging system 100, as shown in FIG. 2B. For example, two calibration plates 106 can be included within the FOV of the imaging device 108 in the imaging system 100. Although FIG. 2B illustrates a single polarization calibration object 102 in one of the calibration plates 106, multiple polarization calibration objects may be included in each of the calibration plates 106. Further, the calibration plates 106 may be removable, allowing users to modify or customize the calibration plates 106 to be used.

FIG. 3 illustrates a top view of a calibration plate 300 that can be implemented in the imaging system 100 of FIGS. 1A, 1C, and 2B. The calibration plate 300 can include a plurality of polarization calibration objects 102 and a plurality of calibration patterns 302. In some cases, the calibration plate 300 can help to assess at least one of a color, a modulated transfer function, a white balance, or imager alignment to physical sample being captured (e.g., via an optical image stabilization (OIS) or equivalent nano-stage mechanism). A processor (e.g., a processor 110) can then generate calibration data in view of the information obtained from the calibration plate 300 for adjusting various components within an imaging system 100 in which a calibration plate 300 may be implemented. The calibration data may be indicative of/show deviations of the light emitted from a light source (e.g., lamp 104) at different relative positions with respect to the polarization calibration object 102 from anticipated light emissions under the same light positions. One example of these deviations may include polarization deviations. As used herein, polarization deviations refer to the change in a phase of polarized light incident on different areas of the polarization calibration object 102 relative to the phase of the polarized light emitted by the light source from an expected direction.

As shown in FIG. 3, the plurality of calibration patterns 302 can include color calibration charts 304, a machine-readable code 305, slanted L patterns 306, alignment fiducials 308, and checkerboard patterns 310. In some cases, regions of the calibration plate 300 that are devoid of polarization calibration objects 102 and calibration patterns 302 (e.g., background regions 312) may be configured to have a glossy finish or a matte finish. In some cases, the entirety of the surface of the calibration plate 300 may be finished with a glossy finish or a matte finish (e.g., the color calibration charts 304 would be glossy or matte depending on which calibration plate 300 they were located on). In some examples, two calibration plates 300 may be implemented in an imaging system 100, where one calibration plate 300 may have a glossy finish, and the second calibration plate 300 may have a matte finish.

In some examples, the different finishes (e.g., glossy and matte finishes) in the calibration plate 300 can aid in specular reflectance tuning of a sample to be imaged relative to the specular or diffuse reflective characterization (e.g., albedo) based on the configured albedo metrics of the presented calibration plate. For example, if a sample is glossy, then a color correction corresponding to this sample may be based on the color calibration charts 304 on a calibration plate 300 having a glossy finish. Similarly, if a sample is matte, then a color correction corresponding to the matte sample may be based on the color calibration charts 304 that are located on a calibration plate 300 having a matte finish. In some cases, the glossy calibration plate may be specified to be at least 80 gloss units for a 60° measurement angle (e.g., the angle between the incident light and a normal of the surface) and the matte calibration plate may be specified to be at least 5 gloss units for a 60° measurement angle. In some cases, the gloss measurements can be implemented at other measurement angles (e.g., 20°, 85°, etc.).

Polarization calibration objects 102 are provided within the calibration plate 300. Two are included in FIG. 3. In some cases, fewer or greater numbers of the polarization calibration objects 102 may be included (e.g., one or three). Also, as described above, alternative shapes may be used for the polarization calibration object 102 (e.g., the polarization calibration object 102 can have a shape that is circular, octagonal, rectangular, triangular, etc.). Light emitted by a lamp 104 is incident on a polarization calibration object 102. In some cases, the lamp 104 (or lamps, when having the light source in the form of a plurality of lamps) are configured for near-light illumination, and the light incident on the polarization calibration object 102 is linearly polarized. In a near-light illumination configuration, the light emitted by a lamp 104 diverges out over an entire area of capture. In this configuration, a slight phase difference can exist in the polarization of the light incident on the different areas. Thus, the polarization calibration object 102 can aid in polarization calibration, as it can help show the change in phase of the polarized light hitting the different areas. In some cases, four polarization calibration objects 102 are provided in the imaging system 100 (e.g., two polarization calibration objects 102 in each of the two calibration plates 106). The four polarization calibration objects 102 can be used to determine the change in phase of the polarized light over the whole field of view and this polarization calibration information can then be used to adjust the image data to provide for more accurate physically based rendering (PBR) surface appearance maps. The calibration data, which includes this polarization calibration information, is determined based on a light distribution from image data pertaining to the light reflected from at least the polarization calibration object 102. This calibration data can be used to adjust the image data of the sample. For example, the calibration data can be used to adjust the image data to be used in generating the PBR surface appearance maps.

PBR surface appearance maps can be used individually or in combination with other PBR surface appearance maps to create highly realistic materials by simulating how light interacts with surfaces. A PBR surface appearance map contributes specific properties to the material, and when used with other PBR surface appearance maps, the combination can enable the rendering engine to produce life-like visuals. For reflective polarization-state data, these PBR surface appearance maps can include generating at least the following PBR surface appearance maps: albedo map, specular map, metallic map, roughness map, and glossiness map. An albedo map can represent the base color of a material without any lighting information, and it defines the color that is diffusely reflected from the surface of the material. The albedo map controls the diffuse reflectance (e.g., the light scattered in many directions due to the microstructure of the surface of the material), and the map's appearance will contain the base colors of the material and can be a flat image without shadows or highlights. A specular map can specify the intensity and color of specular reflections on a surface of a material. The specular map can define how much light is reflected in a mirror-like (specular) manner and define the color of the reflected light. The specular map can influence the color of the specular highlights. The specular map can be grayscale or colored, where the brightness represents the intensity of a specular reflection. A metallic map distinguishes between metal and non-metal surfaces, which can influence how specular and diffuse components are handled. Metals can reflect nearly all light as specular light and non-metals can reflect a mix of diffuse and specular light. The metallic map is binary (e.g., 0 for non-metals and 1 for metals) or grayscale to indicate the degree of metallicity. For example, a metallic map may be a grayscale image where white (or near white) indicates metal and black indicates non-metal. A roughness map can define the microsurface details that scatter light, influencing the sharpness or blurriness of specular reflections. A rough surface scatters light more than a smooth surface, leading to blurred reflections. A smooth surface may reflect light in a more concentrated, mirror-like way. In some cases, the roughness map may be a grayscale image where darker values represent smoother surfaces (e.g., sharp reflections) and light values represent rougher surfaces (e.g., blurred reflections). A glossiness map can essentially be understood to be the inverse of a roughness map (e.g., defines how glossy or shiny a surface is). Higher glossiness values can correspond to smoother, more reflective surfaces. In some cases, the glossiness map may be a grayscale image where lighter values indicate more gloss (e.g., smoother surface) and darker values indicate less gloss (e.g., rougher surfaces).

The polarization of light is altered by the reflectance of the surface, and polarization calibration using the polarization calibration objects 102 can enable a better albedo or specular reflectance and diffuse reflectance degree measurement. Additionally, the polarization calibration objects 102 can facilitate automatic identification/validation of which lamp 104 of the plurality of lamps are on and illuminating the polarization calibration object 102. Accordingly, the use of polarization calibration object 102 in a calibration operation allows for improving the accuracy of image data concerning a sample to be captured in an imaging process.

Color calibration charts 304 can be provided within the calibration plate 300 for color calibration, as shown in FIG. 3. The color calibration charts 304 can include color calibration areas 304a and grayscale calibration areas 304b. The color calibration areas 304a can be used for color correction in the imaging system 100. Color correction is beneficial as it helps to enable accurate color reproduction. The color calibration areas 304a include multiple patches of colors (e.g., twelve color calibration areas or patches are illustrated in FIG. 3) having known color values (e.g., CMYK (cyan, magenta, yellow, and key (black)) or L*a*b* (where L* represents lightness, a* represents red/green values, and b* represents blue/yellow values) color coordinates) as measured separately by tools such as a photometer. These known or exact color coordinate values can serve as reference or target color values in the imaging system 100. To calibrate for color, the color calibration areas 304a in the calibration plate 300 can be imaged within the FOV of the imaging device 108 under lighting conditions that are to be used for an intended sample. An image of the color calibration areas 304a in the calibration plate 300 can be captured and a processor 110 can analyze the image to compare the measured color values against the reference or target color values. The analysis can result in the identification of discrepancies between the measured and the reference color values, which would indicate inaccurate color reproduction. The processor 110 can then determine appropriate color correction values for the color settings of the imaging device 108 and apply the correction values to the color settings of the imaging device 108. This application results in an adjustment of the color reproduction of the imaging device 108 and helps to facilitate more accurate and consistent color reproduction.

The grayscale calibration areas 304b can be used for a white balance function. In photometric imaging systems, to obtain accurate color reproduction, the imaging device 108 white balance setting may need to be adjusted to help ensure that white objects within the FOV of the imaging device 108 that are being imaged will appear white in the images, and this will be independent of the color temperature of the lamp 104 that is used. The grayscale calibration areas 304b can serve as references or targets, for which their values (e.g., CMYK or L*a*b* color coordinates) can be measured separately and/or prior to their implementation in an imaging system 100 through the use of a photometer. As shown in FIG. 3, the grayscale calibration areas 304b can include multiple patches of grayscale-type colors (e.g., six grayscale patches are included in FIG. 3). Thus, when the grayscale calibration areas 304b are imaged under different light sources or lamps 104, the white balance setting of the imaging device 108 can be adjusted following a comparison of the imaged grayscale calibration area 304b values against the photometer-measured, exact values.

In some cases, a machine-readable code 305 can be included in the calibration plate 300, as shown in FIG. 3. This machine-readable code 305 can be used to store calibration information that can be accessed during the imaging process. In some examples, the machine-readable code is a QR code or a 2D barcode that is encoded with factory calibration data corresponding to a plurality of calibration patterns 302. In some examples, the machine-readable code 305 contains the exact color coordinates or color values for the color calibration charts 304. In some examples, these color coordinates or color values may be stored as L*a*b* color coordinates. In some cases, the imaging device 108 captures an image of the calibration plate 300 including the machine-readable code 305 having stored L*a*b* color coordinate values of the color calibration charts 304. A processor 110 can then extract the color coordinates stored in the machine-readable code 305, which correspond to the color calibration charts 304, and can compare the color coordinate values against the measured color values. In some cases, the machine-readable code 305 can be modified or customized to include different or additional calibration data as desired by a user.

Slanted L patterns 306 with high contrast edges are provided within the calibration plate 300. In some cases, the slanted L patterns 306 may be printed onto the calibration plate 300 at a high resolution (e.g., 2400 dpi, or between approximately 1200 dpi and 4800 dpi, or between approximately 1200 dpi and 9600 dpi). Four slanted L patterns 306 are included in FIG. 3. In some cases, fewer or greater numbers of the slanted L patterns may be included (e.g., two or six). The slanted L patterns are slanted at 5 degrees. In some cases, the slanted angle can be in a range of approximately 3 and 8 degrees. The slanted L patterns may be used to implement the slanted edge method to measure a camera's modulation transfer function (MTF), which can indicate how well an imaging device 108 is performing with respect to its resolution (e.g., how well the lenses in an imaging device 108 may be able to maintain contrast at specific resolutions, or how well the imaging device can resolve fine details). With the slanted L patterns 306, the pixels coinciding with the slanted line can be analyzed and used to determine the MTF of the imaging device 108. For example, the pixel values (or light intensity values) of the slanted L pattern's edge can be used to generate an intensity profile that is sigmoidal in shape, or an edge-spread function. Taking a derivative of this edge-spread function yields a line-spread function (indicating how the light spreads from a line), which can be Fourier transformed to obtain an MTF curve. Although slanted L patterns 306 are included in FIG. 3 for the MTF measurement using a slanted-edge method, in some cases, other methods may be used (e.g., a Siemens Star method, a slit method, a three-bar method).

Alignment fiducials 308 may be provided in the calibration plate 300. Four alignment fiducials 308 are included in FIG. 3. In some cases, fewer or greater numbers of the alignment fiducials 308 may be included (e.g., two or six). Between individual image captures that occur in the imaging system 100, certain components may be altered that can result in a pixel shift between images, which can impact subsequent image reconstructions if not corrected. For example, and as described herein, the imaging system 100 can include a polarizer 202 between the calibration plate 300 and the imaging device 108. In some cases, the polarizer 202 may be a linear polarizer, which may be rotated from image to image. Thus, for each image, the pixels may shift slightly as a result of the linear polarizer being rotated. The alignment fiducials 308 are printed on the calibration plate with a high-resolution (e.g., 2400 dpi, or between approximately 1200 dpi and 4800 dpi, or between approximately 1200 dpi and 9600 dpi) printer and the center of each of the alignment fiducials 308 includes an intersection point 309. For each image captured, an image of the alignment fiducials 308 including the intersection point 309 is also included. Consequently, a first image including the alignment fiducials 308 can be compared with at least a second image including the same alignment fiducials 308, and the pixel shift can be analyzed by observing the amount by which the intersection point 309 has shifted image to image (e.g., between the first image and the second image). The amount of pixel shift is a part of the calibration data that can be collected by the processor 110 in the imaging system 100. This quantified shift is based on the pixel position of the intersection points 309 of the high-resolution alignment fiducials 308.

In some cases, this pixel-shift calibration can be done during an image acquisition process. For example, the position of the imaging device 108 can be adjusted between image captures of the sample. In some cases, a linear polarizer (e.g., polarizer 202) is rotated to a first angle, and the imaging device 108 obtains a first image of at least the calibration plate 300. The linear polarizer is rotated to a second angle, and the imaging device 108 obtains a second image of the calibration plate 300 and the processor 110 determines how much pixel shift has occurred by analyzing how much the intersection point 309 of each alignment fiducial 308 has moved between the first image and the second image. This information can then be used to adjust the position of the imaging device 108 to acquire a subsequent image of the calibration plate 300 and sample that is aligned at the pixel level to the previous image that was acquired, and the images can be stored in a memory (e.g., memory 510) for later image reconstruction. Beneficially, this alignment process can occur during an image acquisition process for an actual sample, which can reduce the amount of time needed to acquire, analyze, and reconstruct images pertaining to a sample of interest. Further, this real-time process can result in reduced information loss. Post-image acquisition image alignment can be performed with the imaging system 100, but can result in information loss in some cases because in post-imaging, when a second image is compared against a first image for pixel alignment, shifting the second image relative to the first image may result in a final second image that is smaller than the original second image, as some amount of the boundaries of the original second image will likely be outside the boundaries captured by the first image.

In some cases, this pixel-shift calibration can be completed before an image acquisition process is to be carried out on an actual sample. For example, images of the alignment fiducials 308 in the calibration plate 300 can be captured for each polarization viewing state for each lamp to be used (or for each position a single lamp is moved to). The pixel shift of the intersection point 309 of each alignment fiducial 308 can be determined for each image and the pixel shift amounts can be stored in a memory (e.g., memory 510). The values stored in this memory can be accessed by the processor 110 during an image acquisition process of an actual sample, and the processor 110 can instruct the imaging device 108 to shift its position according to the pixel shift amounts. In some cases, the alignment fiducials 308 can have a different configuration. For example, the alignment fiducials could have a square shape instead of the circular one shown in FIG. 3, or they could include a crosshair with no enclosing boundary.

Additional calibration patterns such as the checkerboard patterns 310 in FIG. 3 can be included to assess for possible image distortion. These checkerboard patterns 310 may be printed at high-resolution (e.g., 2400 dpi, or between approximately 1200 dpi and 4800 dpi, or between approximately 1200 dpi and 9600 dpi), and may aid in understanding the optical imaging stabilization (OIS) offset alignment areas and/or the focusing of the imaging device 108 in the imaging system 100. For example, the checkerboard patterns 310 can be used to identify and correct barrel or pincushion distortion in lenses. In some cases, a grid pattern chart may be implemented instead of the checkerboard patterns 310. Other calibration patterns that can be implemented on the one or more calibration plates 300 can include: gray scale/step wedge charts for calibrating a camera's exposure and/or dynamic range, resolution/sharpness charts (e.g., Siemens star) for calibrating sharpness/resolution and/or lens performance, chromatic aberration charts for calibrating chromatic aberration, flat field/uniformity charts for calibrating for vignetting and/or sensor uniformity, and more.

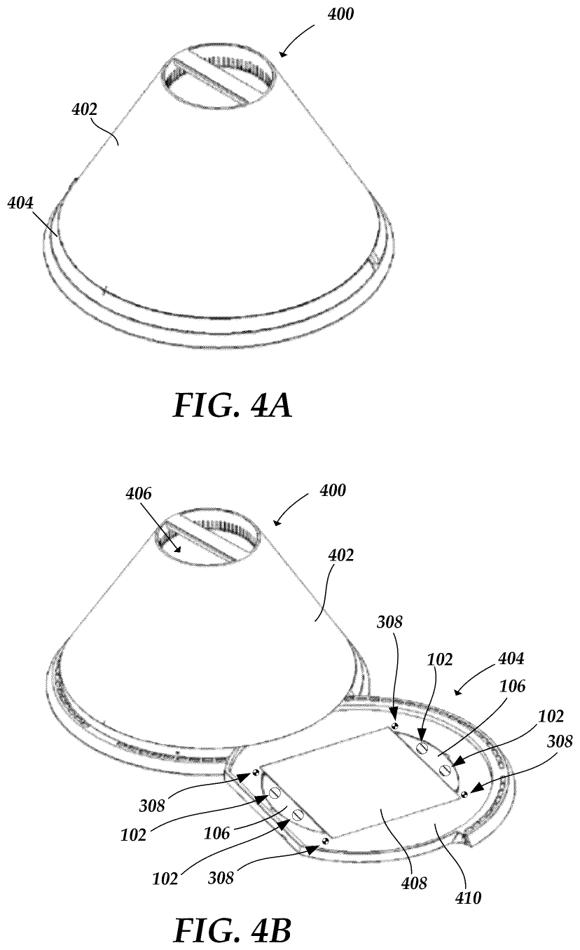

FIG. 4A illustrates a schematic view of a housing 400 for an imaging system 100, where the housing 400 can include two portions (e.g., a first portion 402 and a second portion 404). In some cases, the first portion 402 can be an upper portion of the housing 400 defining an inner volume 406 in which the lamps 104 and the imaging device 108 can be positioned. The second portion 404 can be a lower portion of the housing 400 that couples to the first portion 402. The second portion 404 can include a sample region 408 (e.g., a target area) located within a sample tray 410 upon which a polarization calibration object 102 and/or a sample can be placed for imaging. In some cases, the sample tray 410 can be accessed by rotating it outward or away from the first portion 402. Although FIG. 4B shows the second portion 404 in an open configuration in which the second portion 404 remains attached to the first portion 402, in some cases, the second portion 404 can be completely separated and detached from the first portion 402. In some examples, the second portion 404 can be separated from the first portion 402 through a rotating mechanism, such that the second portion 404 can be rotated away from the first portion 402 to make the sample tray 410 accessible to a user. In some cases, the second portion 404 can be displaced with respect to the first portion 402 through a non-rotating or linear sliding mechanism. In some examples, the first portion 402 may comprise an aperture to receive a sample tray 410 that is removable or movable relative to the first portion 402. In some cases, inserting the sample tray 410 of the second portion 404 completely into the aperture may function to block or reduce ambient light (or background light) from entering the near-light photometric PBR apparatus.

In some examples, the sample region 408 is a removable target area relative to the imaging device 108. In some examples, the sample tray 410 can include one or more receptacles to receive a calibration plate (e.g., calibration plate 106 previously described with reference to FIGS. 1A and 2B or the calibration plate 300 previously described with reference to FIG. 3). As shown in FIG. 4B, two calibration plates (e.g., calibration plates 106, 300) can be placed on the sample tray 410 such that they are located at the outer periphery of the sample region 408 and are symmetrically arranged about the sample region 408. In some cases, alignment fiducials 308 may be included directly on the base of the enclosure or housing (e.g., the sample tray 410) of the imaging system 100, which is exterior to the calibration plate 300. These fiducials may be laser-etched fiducials that are permanently included in the base. These fiducials may be used to calculate the field of view plane for the imaging system 100. In some cases, these fiducials may also be used to calibrate pixel shift as described herein. As shown in FIG. 4B, four alignment fiducials 308 can be formed on the base in the second portion 404 of the housing 400.

The first portion 402 can include a rigid conical structure to house at least a first lamp (e.g., lamp 104). The rigid conical structure can include an interior surface that is angled, such that when a lamp 104 is positioned on the interior surface, the lamp 104 may be positioned such that light emitted from the lamp will have a low grazing angle (e.g., approximately 30 degrees) relative to the sample region 408. In some examples, where the imaging system 100 includes eight lamps, the eight lamps can be arranged in an octagonal configuration that is approximately centered with respect to the imaging device 108.

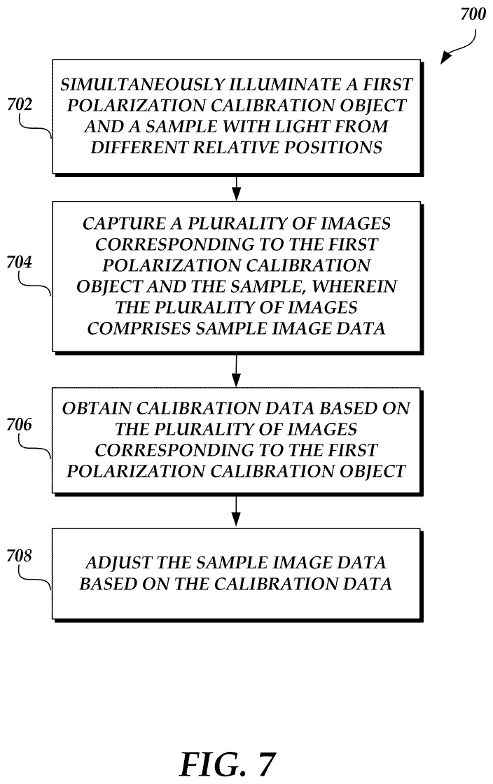

In some examples, the calibrations can be implemented during imaging of the sample. In such cases, the imaging system can include a light source (e.g., lamp 104), an imaging device 108, a polarization calibration object 102, and a target area 126 including a sample (see, for example, FIGS. 1C and 2B). The field of view (FOV) of the imaging device 108 can encompass both the polarization calibration object 102 and the target area 126 including the sample, which can allow for the imaging and calibration processes to occur during an imaging operation of the sample. This imaging operation or imaging process is described further with respect to FIG. 7. Calibrations during imaging operations allow for reducing the overall time compared to systems that implement the calibration before the imaging operation. Additionally, implementing the calibration operation in parallel to the imaging operation allows for ensuring that any potential change in the imaging system in a time defined between the calibration operation and the imaging operation does not negatively affect the result of the imaging operation.

### Example Calibration Process

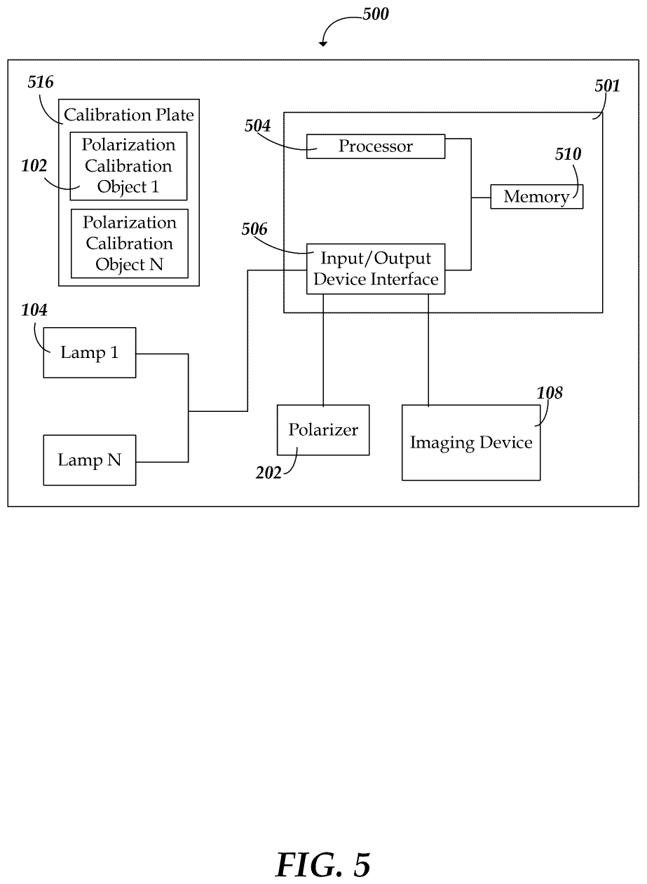

FIG. 5 illustrates a schematic block diagram depicting an illustrative general architecture of an imaging system 500 (e.g., a photometric imaging system configured for near-light illumination), which may correspond to any of the imaging systems previously described in FIGS. 1A, 1C, and 2B. The imaging system 500 can include a plurality of lamps 104, a controller 501 (control or processing unit), an imaging device 108 (e.g., camera), a polarizer 202, and a calibration plate 516 including at least one polarization calibration object 102 (e.g., Polarization Calibration Object 1-Polarization Calibration Object N, where N is greater than 1). The controller 501 can include a processor 504 and an input/output device interface (e.g., I/O device interface 506). In some examples, the I/O device interface 506 can include an I/O port to facilitate the exchange of information between the imaging system 500 and an external device (not shown).

In some examples, the controller 501 can include a network interface (not shown). In some examples, the network interface can allow for short-range wireless connections (e.g., Bluetooth® or Wi-Fi connection). The controller 501 components can communicate with one another by way of a communication bus. The controller 501 is associated with, or in communication with, at least one output device and at least one input device. For example, the output device can be the lamp 104 (e.g., Lamp 1-Lamp N, where N is greater than 1). The network and/or host computer interface can provide the controller 501 with connectivity to one or more networks or computing systems. The processor 504 can thus receive information and instructions from other processing systems or services via a network (e.g., wireless personal area network (WPAN), local area network (LAN), etc.). The processor 504 can also communicate to and from the memory 510 and further provide output information (e.g., a plurality of images) for an output device (e.g., a display (not shown)) via the I/O device interface 506. The I/O device interface 506 can accept input from an input device (e.g., imaging data or information acquired from the camera). The memory 510 can contain computer program instructions that can be executed by the processor 504. In some examples, the memory 510 can include RAM, ROM, and/or other persistent or non-transitory computer-readable storage media. The controller 501 further includes a power source for providing power to the controller 501.

In some examples, the processor 504 facilitates the operation of at least the imaging device 108 and at least one of each of the lamps 104. The imaging device 108 can be removable or fixed within the imaging system 500. The processor 504 can control turning on or off individual lamps 104, such that only a single lamp is on at a time to illuminate a calibration plate 516 and/or a sample. Further, the processor 504 can control the lamps 104 to subsequently emit light from the different positions of the lamps 104, and the processor 504 can control the imaging device 108 to capture a plurality of images under different light settings (e.g., the relative position of the lamp 104 with respect to the polarization calibration object 102), where the plurality of images contains image data pertaining to at least a polarization calibration object 102 (in some cases, a plurality of polarization calibration objects or a calibration plate 516) illuminated by a lamp 104. For example, the processor 504 can have a light source (e.g., lamp 104) illuminate a polarization calibration object 102 from different relative positions, instruct the imaging device 108 to capture images having image data of a polarization calibration object 102 (or in some cases, a calibration plate 516) illuminated by the light source from the different relative positions, and then process the image data to obtain calibration data (described herein) based on the images corresponding to the first polarization calibration object in the imaging system 500. For example, the processor 504 may determine a light distribution from the collected image data and determine the calibration data based on the light distribution. In some cases, a subset of the image data may be used by the processor 504 to determine the light distribution from the first polarization calibration object 102. The use of a subset of the image data instead of all the image data allows for saving computational resources during the calibration process. In some examples, a first subset of the image data corresponding to the first polarization calibration object may be used to obtain the calibration data. In some cases, the processor 504 can have a light source (e.g., lamp 104) illuminate two or polarization calibration objects 102 (e.g., at least a first polarization calibration object and a second polarization calibration object) from different relative positions using the light source, instruct the imaging device 108 to capture images having image data of the two or more polarization calibration objects 102 illuminated by the light source from the different relative positions, and then process the image data to obtain calibration data (described herein) based on the images corresponding to the two or more polarization calibration objects 102 in the imaging system 500. In some examples, the first subset of image data can include the first polarization calibration object, and the second subset of image data can include the target area. In some cases, the processor 504 can calibrate the second subset of the image data based on the first subset of image data in an image capturing operation.

In some cases, all of the image data may be used by the processor 504 to determine the light distribution from the first polarization calibration object 102. In other examples, the processor 504 may analyze images captured by the imaging device 108, where the images contain information on the light reflected from a polarization calibration object 102 and a plurality of calibration patterns 302 in the calibration plate 516. The processor 504 can compute or determine at least a light direction and a light polarization state. In some cases, the processor 504 can then apply the calibration data to the image data to make adjustments to various parameters or image data maps pertaining to the phase or elliptical orientation of the linear polarized light incident on the polarization calibration object 102 to improve albedo (specularity/diffuseness of reflection) measurements.

In some cases, the calibration plate 516 also includes a plurality of calibration patterns 302, and the calibration plate 516 may have a configuration similar to the calibration plate 300 (which includes polarization calibration objects 102) shown in FIG. 3. In some examples, the processor 504 can analyze the light reflected off of the plurality of calibration patterns 302 illuminated by a lamp 104 and obtain calibration data to assess and correct color values (e.g., white balance correction, color correction). In some cases, the calibration plate 516 includes a machine-readable code 305 (e.g., a QR code) containing exact color values (e.g., L*a*b* color coordinates) for the color calibration charts 304 that may be included in the calibration plate 516. The processor 504 can retrieve these exact color values from the machine-readable code 305, compare them against measured color values, and apply color correction values as needed to the color settings of the imaging device 108.

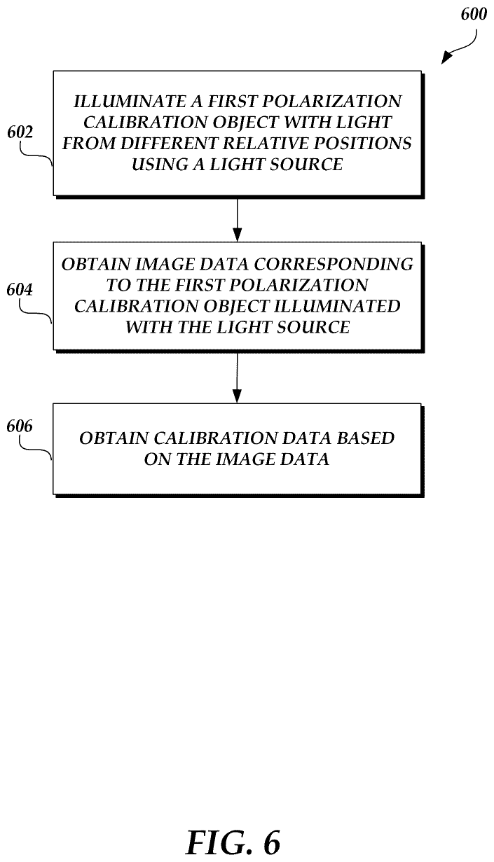

FIG. 6 illustrates an example calibration process 600 (or calibration method) for an imaging system 100. FIG. 6 describes the calibration process 600 for an imaging system 100 that includes at least one polarization calibration object 102. In some cases, the calibration process 600 can be implemented for an imaging system 100 that includes a calibration plate 106 or 300 including at least one polarization calibration object 102 and/or a plurality of calibration patterns 302. In some cases, the process described in FIG. 6 can apply to processes implementing more than one lamp 104. Different light settings (e.g., relative positions of the light source with respect to the polarization calibration object 102) may be provided using one or more lamps 104. For example, a first lamp may emit light in accordance with a plurality of light settings (e.g., the first lamp can be moved to different relative positions relative to the polarization calibration object 102) to be used in the imaging. Additionally, a polarizer 202 may be adjusted to different polarization viewing states, and together, the different light settings and the different polarization viewing states define an illumination setting. As used herein, the term “illumination settings” will be used to refer to the combination of the light settings and the polarization viewing states.

At block 602, the calibration process 600 comprises illuminating a first calibration object 102 with light from different relative positions using a light source. For example, a lamp 104 may emit light at a first light setting, which may include at least a first orientation of the light. In some cases, the light source can include multiple lamps (e.g., lamp 104) in the imaging system 100. In some examples, the light source is a near-light light source, and the light emitted by the near-light light source is conditioned such that it is approximately uniformly distributed across a sample region including the first polarization calibration object 102. The light emitted by the light source may be devoid of hotspots and sharp transitions between a light edge against a background.

At block 604, image data corresponding to the first polarization calibration object 102 can be obtained by the imaging device 108 (e.g., a camera) in the imaging system 100. The image data can include information on the light reflected from the first polarization calibration object 102 illuminated with the light source from different relative positions. In some cases, the image data pertains to a single polarization calibration object. In some cases, the image data pertains to multiple polarization calibration objects (e.g., two polarization calibration objects). For example, the image data can include information pertaining to both the light reflected from a first polarization calibration object and a second polarization calibration object. Obtaining the image data for the first and the second polarization calibration objects can include capturing a plurality of images corresponding to the first and the second polarization calibration objects as they are illuminated at the same time with a light source from different relative positions. The calibration data can subsequently be obtained based on the image data corresponding to the first and the second polarization calibration objects.

In some cases, the image data pertains to one or more calibration plates 106, 300. In some cases, the image data pertains to alignment fiducials 308 etched into the sample tray 410 of the second portion 404 of the housing 400 in an imaging system 100 in addition to one or more calibration plates. In some cases, the image data can correspond to light reflected at least from one or more polarization calibration objects and a sample. For example, a sample and a plurality of calibration objects can be illuminated at the same time with light from different relative positions using a light source. The number of images captured can depend on whether calibrations are to be performed before, during, or after an image capture process of an intended sample. For example, between 500 and 3000 images, or between 2000 and 3000 images may be captured where calibrations may be performed during or after an image capture process. Fewer images may be obtained where calibrations are to be completed prior to an image capture process of an intended sample.

At block 606, the calibration data is obtained based on the image data corresponding to the polarization calibration object. For example, a processor 110 can analyze the image data contained in the plurality of images corresponding to the polarization calibration objects 102 and generate corresponding calibration data (as described herein). In some cases, the image data analyzed corresponds to the polarization calibration objects 102 and/or the plurality of calibration patterns 302. In some cases, the image data in each image captured can contain pixels having values corresponding to light intensity values, which contain information regarding how light is reflected from the surface of the one or more calibration plates 106 or 300. In some cases, for each calibration target on a calibration plate, the processor can extract corresponding pixel value information from the collected image data and perform various computations depending on the calibration goal. For example, the processor can extract pixel value information relevant to the alignment fiducials 308 between subsequent images to determine how much pixel shift has occurred between image acquisitions. In some cases, the calibration data can be arranged in a table or map and stored in a memory 510 until retrieved or accessed by the processor 110 in a later operation.

After obtaining the calibration data, the processor 110 can adjust the image data based on the calibration data. In some cases, the image data includes subsets of image data, which can save computational resources. For example, one subset of image data can include the polarization calibration object, from which the calibration data can be determined, and another subset of image data can include the sample, such that the processor can adjust the subset of the image data including the sample based on the calibration data. In some cases, the calibration data corresponding to the light incident on multiple polarization calibration objects 102 can contain information showing the change in phase of the polarized light incident on different areas of the polarization calibration objects 102. When multiple polarization calibration objects 102 are included in the field of view of the imaging device 108, the corresponding calibration data can be used to understand the change in phase of the polarized light over approximately the entire field of view. In some examples, this phase change information may have been stored in a memory 510 at the operation performed at block 606. The processor 110 can subsequently access the stored information and adjust image data pertaining to a sample to account for the change in phase of the polarized light over the field of view.

In some cases, the calibration data may also be used to adjust a component of the imaging system 100. For example, with respect to white balance correction, the processor 110 can adjust the white balance settings of the imaging device 108 (e.g., a camera) if a discrepancy was found after comparing measured grayscale values of the grayscale calibration areas 304b against the exact color values.

In some cases, a polarizer (e.g., polarizer 202) can be placed between the first polarization calibration object 102 and an imaging device 108. The polarizer may be adjusted to facilitate the transmission of light having a first particular polarization to be captured by the imaging device. For example, the polarization state can be modified to a plurality of polarization viewing states, and the image data obtained can include capturing a plurality of images under the plurality of polarization viewing states while a polarization calibration object is illuminated with a light source from different relative positions. Calibration data can subsequently be obtained for the plurality of polarization viewing states. In some cases, the polarizer may be an optical filter such as a liquid crystal tunable filter, where the polarization viewing state can be adjusted through varying a drive current provided to the liquid crystal tunable filter. In some cases, the polarizer is a linear polarizer that can be physically rotated to adjust a polarization angle, and consequently adjust the polarization viewing state.

In some cases, at least some operations of the calibration process 600 may be instructions stored in a computer-readable medium that can instruct a processor (e.g., the processor 110) to cause elements of the imaging system 100 to perform the operations. For example, operations associated with the blocks 602, 604, and 606 may be performed by the processor 110 in response to executing instructions stored in a volatile or non-volatile memory.

In some cases, the calibration process 600 can be performed before imaging an intended sample of interest (or sample). The white balance correction is one example calibration process that can be performed before imaging an intended sample. In some cases, the calibration process 600 can be performed during imaging of an intended sample of interest. For example, pixel shift calibrations can be performed during the imaging, and the imaging device 108 positions can be adjusted in response to the pixel shift calibrations. In some cases, the calibration process 600 can be performed after imaging of an intended sample of interest. Every image acquired of the sample of interest will also include an image of the polarization calibration object 102 (e.g., the polarization calibration object can be implemented on its own without a calibration plate 106, 300) or one or more calibration plates 106, 300 (each of which includes at least one polarization calibration object 102). Additionally, the intended sample of interest is imaged in an imaging operation under the same light settings as those used during the calibration process 600. Beneficially, calibration data can be collected and stored with every single image acquired in the imaging system 100, which can allow for post-imaging calibration corrections of images.

### Example Imaging Process Involving Calibration

In some cases, the imaging system 100 can facilitate the imaging process 700 in FIG. 7, which essentially includes the example calibration process 600 as shown in FIG. 6 and additional processes pertaining to the concurrent illumination of a sample. Beneficially, the imaging process 700 makes possible the capability of implementing calibration processes at the same time as the imaging of a sample (e.g., a target sample material). Unless otherwise noted, the calibration process portion of the imaging process 700 illustrated in FIG. 7 is the same as or generally similar to the calibration process 600 of FIG. 6, and alternatives noted above with respect to FIG. 6 are likewise applicable to the imaging process 700 of FIG. 7.

FIG. 7 describes the imaging process 700 for an imaging system 100 that includes at least one polarization calibration object 102. Unlike in FIG. 6, at block 702, both the first polarization calibration object 102 and the sample may be illuminated at the same time with light at a first illumination setting. For example, both the first polarization calibration object 102 and the sample can be illuminated with light from a light source (e.g., a lamp 104) from different positions relative to the polarization calibration object 102 and the sample. In some cases, a single lamp may be used and moved to different positions relative to the polarization calibration object 102 and the sample. In some cases, multiple lamps may be arranged at different positions relative to the polarization calibration object 102 and the sample within the imaging system 100. At block 704, a plurality of images corresponding to the first polarization calibration object 102 and the sample can be captured by the imaging device 108 (e.g., a camera) in the imaging system 100, and the plurality of images can comprise sample image data (i.e., image data pertaining to the sample itself). Each image can include the image data of light reflected from the first polarization calibration object 102 and the sample. In some cases, the image data pertains to a single polarization calibration object and the sample. In some cases, the image data pertains to multiple polarization calibration objects (e.g., two calibration objects) and the sample. For example, obtaining the image can include capturing a plurality of images corresponding to a sample and a plurality of calibration objects (or polarization calibration objects) that are illuminated with a light source from different relative positions. In some cases, the image data pertains to the sample and at least one calibration plate 106, 300 including at least one polarization calibration object 102. The number of images captured can be between 500 and 3000 images, or between 2000 and 3000 images. At block 706, the calibration data is obtained based on the plurality of images corresponding to the first polarization calibration object 102. For example, a processor 110 can analyze the image data corresponding to the polarization calibration objects 102 (and/or the plurality of calibration patterns 302) and generate corresponding calibration data (as described herein). In some cases, the calibration data is based on a plurality of images corresponding to two or more polarization calibration objects 102, or at least one calibration plate 106, 300 that includes at least the first polarization calibration object 102. For example, obtaining the calibration data can include determining a first subset of the image data corresponding to the plurality of calibration objects. At block 708, the processor 110 can adjust the sample image data based on the calibration data. For example, based on the first subset of the image data corresponding to the plurality of calibration objects, a second subset of the image data corresponding to a sample can be adjusted. As was described with respect to FIG. 6, calibration data corresponding to the light incident on multiple polarization calibration objects 102 can contain information showing the change in phase of the polarized light incident on different areas of the polarization calibration objects 102. The inclusion of multiple polarization calibration objects 102 in the field of view of the imaging device 108 can yield calibration data that can be used to understand the change in phase of the polarized light over approximately the entire field of view, and thus can be used to make any adjustments to the sample image data.

Utilizing in situ calibration targets (e.g., the polarization calibration objects 102 and/or plurality of calibration patterns 302) in an imaging system 100 may help in physically based rendering (PBR) processes by helping to ensure a more accurate representation of how light interacts with various materials imaged in an imaging system 100. The polarization calibration objects 102 can be formed from materials that are optically reflective, and the polarization calibration objects 102 may have a surface configuration to visually indicate a polarization orientation of light emitted by a lamp in the imaging system 100. Additionally, the inclusion of a plurality of calibration patterns 302 can aid in ensuring the imaging system 100 is capturing the real colors of a sample through the inclusion of color calibration charts 304. Beneficially, the polarization calibration objects 102 and the plurality of calibration patterns 302 may be placed within the field of view of the imaging device 108 in the imaging system 100, which allows for the acquisition of images where each image contains an image of the polarization calibration objects 102 and/or the plurality of calibration patterns 302. This simultaneous acquisition can allow for calibrations to be carried out at least during imaging of an intended sample or after the imaging has been completed.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. An imaging system comprising:
a first calibration plate comprising a first calibration object, the first calibration object comprising a first surface configuration to visually indicate a polarization orientation of light emitted thereto;
a light source to emit light in accordance with a plurality of light settings, each of the light settings defining a different relative position of the light source with respect to the first calibration object;
an imaging device; and
a processor to instruct the imaging device to capture a plurality of images of the first calibration object illuminated with the light source with different light settings of the plurality of light settings and to calibrate image data corresponding to a sample under the same different light settings based on the plurality of images captured by the imaging device.

2. The imaging system of claim 1, wherein the first surface configuration comprises a plurality of peaks and a plurality of grooves, and wherein a pitch of the plurality of grooves is in a range of approximately 0.4 μm-5 mm.

3. The imaging system of claim 1, wherein the first surface configuration comprises an optically reflective material having a fabricated surface, and wherein the optically reflective material comprises an albedo in a range between approximately 0.5 and 1.0.

4. The imaging system of claim 1, further comprising a second calibration plate, the second calibration plate including a second calibration object comprising a second surface configuration to visually indicate the polarization orientation of light emitted thereto, wherein the plurality of images captured by the imaging device further comprises images of the second calibration object illuminated with the different light settings of the plurality of light settings.

5. The imaging system of claim 4, further comprising a target area to receive the sample, wherein the target area is located between the first calibration plate and the second calibration plate.

6. The imaging system of claim 1, wherein the first calibration plate further comprises a plurality of calibration patterns to assess at least one of, a color, a modulated transfer function, a white balance, or a pixel alignment, wherein the plurality of images captured by the imaging device includes the plurality of calibration patterns.

7. The imaging system of claim 6, wherein the first calibration plate further comprises a machine-readable code to store calibration information corresponding to at least one of the plurality of calibration patterns, and wherein the plurality of images captured by the imaging device includes the machine-readable code.

8. The imaging system of claim 1, wherein the first calibration plate comprises a plurality of calibration objects, wherein the plurality of calibration objects includes the first calibration object, wherein the plurality of images includes images of the plurality of calibration objects illuminated with the light source with the different light settings of the plurality of light settings.

9. The imaging system of claim 1, wherein the light source includes a first lamp located at a first position relative to the first calibration object and a second lamp located at a second position relative to the first calibration object, wherein the first lamp is to emit light in a first light setting and the second lamp is to emit light in a second light setting, wherein the first lamp and the second lamp do not emit light at the same time.

10. An imaging system comprising:
a plurality of lamps arranged to emit light from different positions within the imaging system;
a first calibration object comprising a first surface configuration to reflect light from the plurality of lamps;
an imaging device having a field of view including the first calibration object; and
a processor to control the plurality of lamps to subsequently emit light from the different positions, the imaging device to obtain image data corresponding to the first calibration object while the first calibration object reflects the light emitted by the plurality of lamps, and the processor to obtain calibration data to be used in an image capturing operation based on the image data.

11. The imaging system of claim 10, further comprising a polarizer to provide a plurality of polarizer viewing states, the polarizer disposed between the imaging device and the first calibration object, and the imaging device to capture a plurality of images comprising the image data, wherein the plurality of images captured are of the first calibration object illuminated with light emitted from different relative positions with respect to the first calibration object and with a polarizer viewing state, and wherein the calibration data is obtained for the plurality of polarizer viewing states.

12. The imaging system of claim 10, further comprising a housing defining an inner volume, wherein the housing comprises a first portion movably coupled to a second portion, wherein the first portion comprises the plurality of lamps, wherein the housing further comprises an aperture to receive the second portion, wherein the second portion comprises a sample tray comprising a target area, and wherein the second portion is movable relative to the aperture to provide access to the sample tray when moved away from the aperture.

13. The imaging system of claim 12, further comprising a first calibration plate, wherein the first calibration plate comprises the first calibration object, and wherein the sample tray comprises a first receptacle to receive the first calibration plate.

14. The imaging system of claim 10, further comprising a target area to receive a sample, wherein the field of view of the imaging device comprises the target area and the first calibration object, the processor to calibrate a second subset of the image data including the target area based on a first subset of image data including the first calibration object in the image capturing operation.

15. The imaging system of claim 10, wherein the processor is to obtain the calibration data based on a light distribution, and wherein the light distribution is determined based on a subset of the image data concerning the first calibration object.

16. The imaging system of claim 10, further comprising a plurality of calibration objects, the plurality of calibration objects including the first calibration object and a second calibration object comprising a second surface configuration to reflect light from the plurality of lamps and laterally spaced relative to the first calibration object, wherein the field of view of the imaging device comprises the first calibration object and the second calibration object, the processor to obtain the calibration data from the image data.

17. A calibration method comprising:
illuminating a first calibration object with light from different relative positions using a light source, the first calibration object having a first surface configuration to visually indicate a polarization direction of light emitted by the light source;
obtaining image data corresponding to the first calibration object illuminated with the light source from the different relative positions; and
obtaining calibration data based on the image data corresponding to the first calibration object,
wherein the calibration data is indicative of polarization deviations of the light emitted from the light source from the different relative positions.

18. The calibration method of claim 17, further comprising modifying a polarization viewing state of a polarizer to a plurality of polarization viewing states, wherein the polarizer is between the first calibration object and an imaging device, wherein obtaining the image data comprises capturing a plurality of images under the plurality of polarization viewing states while the first calibration object is illuminated with the light source from the different relative positions, and wherein the calibration data is obtained for the plurality of polarization viewing states.

19. The calibration method of claim 17, further comprising:
illuminating a second calibration object with light from the different relative positions using the light source, the second calibration object having a second surface configuration to visually indicate a polarization direction of light emitted by the light source, wherein obtaining the image data comprises capturing a plurality of images corresponding to the first calibration object and the second calibration object illuminated with the light source from the different relative positions, and wherein obtaining the calibration data comprises obtaining the calibration data based on the image data corresponding to the first calibration object and the second calibration object.

20. The calibration method of claim 17, further comprising:
illuminating a sample and a plurality of calibration objects at the same time with light from the different relative positions using the light source, the plurality of calibration objects having a surface configuration to visually indicate a polarization direction of light emitted by the light source and including the first calibration object, wherein obtaining the image data comprises capturing a plurality of images corresponding to the sample and the plurality of calibration objects illuminated with the light source from the different relative positions, and
wherein obtaining the calibration data comprises determining a first subset of the image data corresponding to the plurality of calibration objects; and
adjusting a second subset of the image data corresponding to the sample based on the first subset of the image data.
